(19) United States
(12) Patent Application Publication
(10) Pub. No.: US 2025/0246840 A1
(43) Pub. Date: Jul. 31, 2025

(54) ELECTRICAL CONNECTOR

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Xiaoxian TIAN, Shanghai (CN); Yingquan JING, Shanghai (CN)

(21) Appl. No.: 19/037,364

(22) Filed: Jan. 27, 2025

(30) Foreign Application Priority Data
Jan. 25, 2024 (CN) 202410113593.6

(51) Int. Cl. H01R 13/436; H01R 13/52

(52) U.S. Cl. CPC H01R 13/4364; H01R 13/5202

(57) ABSTRACT

An electrical connector includes a main shell with one or more terminal channels extending in a first direction, designed to house terminals. The connector features a terminal locking component that mates with the main shell, comprising a base, a terminal pressing plate, and a secondary limiting plate. The terminal pressing plate applies a retaining force to the terminals within the channels, ensuring secure placement. The secondary limiting plate establishes a defined relative position between the main shell and the terminal locking component, enhancing stability and alignment. This configuration facilitates reliable electrical connections by maintaining terminal integrity and positional accuracy within the connector assembly.

### CROSS-REFERENCE TO RELATED APPLICATION

This application claims benefit of priority to Chinese Patent Application No. 202410113593.6 filed on Jan. 25, 2024, the entire disclosure of which is hereby incorporated by reference.

### TECHNICAL FIELD OF THE INVENTION

This application relates to electrical connector, including but not limited to the field of coaxial electrical connector technology.

### BACKGROUND

At present, an electrical connector, such as a coaxial connector, may include a main body to contain terminal and part of the cable, and a locking part to tighten the terminal, for example, a part referred to as terminal position assurance (TPA). When the locking part is mated with the main body, only locking for the terminal is considered, and after the retaining force for locking terminal is applied, the intended connection between the main body and the locking part is deemed to be achieved. There is no mechanism to further secure the main body and the locking part together. In complex application environments, the main body and the locking part are often prone to be disconnected.

Electrical connectors are essential components in a wide range of electronic devices, providing the necessary interface for electrical signals to pass between various parts of a system. Traditional electrical connectors often employ an uncomplicated design where terminals are inserted into channels within a main shell, and a separate locking mechanism is used to secure the terminals in place. These designs typically rely on friction or mechanical interference to maintain terminal position, which can lead to issues such as terminal misalignment or disconnection under mechanical stress or vibration.

In some previous approaches, electrical connectors have incorporated locking components that are integrated into the main shell. These integrated locking mechanisms often include a single locking plate or clip that applies pressure to the terminals to hold them in place. While this design can simplify assembly and reduce the number of parts, it may not provide sufficient retention force for all applications, particularly in environments subject to elevated levels of vibration or thermal cycling. Additionally, the integrated nature of these locking mechanisms can make it difficult to adjust or replace individual terminals without disassembling the entire connector.

Other designs have introduced more complex locking systems that include multiple components to enhance terminal retention. These systems may use additional plates or clips that interact with the main shell and terminals to provide a more secure connection. However, these designs can increase the complexity and cost of the connector, as well as complicate the assembly process. Furthermore, the added components can introduce new points of failure, potentially reducing the overall reliability of the connector.

However, none of these approaches have provided a comprehensive solution that combines the features described in this disclosure.

### SUMMARY

This application proposes an electrical connector to solve the problem of disconnection due to insufficient retaining force between the main body and the locking part. According to an aspect of this application, an electrical connector is provided, the electrical connector comprises a main shell having one or more terminal channels extending along a first direction, and the terminal channel is configured to contain terminal; and a terminal locking component, the terminal locking component is configured to be mated with the main shell, the terminal locking component includes a terminal pressing plate and a secondary limiting plate, the terminal pressing plate is configured to apply retaining force to terminal within the terminal channel, the secondary limiting plate is configured to define the relative position between the main shell and the terminal locking component.

As compared with the prior art, the electrical connector proposed by this application, relying on additional locking mechanism, provides enhanced locking between the main shell and the terminal locking component.

According to an aspect of this application, an electrical connector is provided, the electrical connector includes a main shell defining an inner space extending along a first direction, a terminal channel is provided within the main shell and a plurality of secondary components. The secondary components include a terminal locking component and an end cover component. The terminal locking component configured to be contained within the main shell, and the end cover component configured to be mated with the rear end of the main shell. The end cover component and the main shell are capable of being pre-assembled together in a first positional relationship having a gap and are capable of being fully mated in a second positional relationship with no gap.

As compared with the prior art, the electrical connector proposed by this application has main shell and secondary components which can be pre-assembled together and can be delivered to downstream customer in the pre-assembled status, such that a subsequent terminal insertion operation can be carried out directly.

### BRIEF DESCRIPTION OF THE DRAWINGS

In order to provide a clearer explanation of the technical solution in the embodiments of the present application, a brief introduction will be given to the drawings to be used for depicting the embodiments. It is obvious that the drawings described below are only some embodiments of the present application. For those skilled in the art, other drawings can be conceived based on these drawings without creative labor.

FIG. 1 is a perspective view of an electrical connector according to some embodiments.

FIG. 2 is a side view of an electrical connector according to some embodiments.

FIG. 3 is a cross-section view of the electrical connector at line A-A in FIG. 2 according to some embodiments.

FIG. 4 is an exploded perspective view of an electrical connector according to some embodiments.

FIG. 5 is a perspective view of a main shell of an electrical connector according to some embodiments.

FIG. 6 is a second cross-sectional view of an electrical connector according to some embodiments.

FIG. 7 is perspective view of a terminal locking component of an electrical connector according to some embodiments.

### DETAILED DESCRIPTION

The following will, with reference to the accompanying drawings for the embodiments, provide a clear and complete description of the technical solution the present application. Obviously, the embodiments being depicted are only a part of the embodiments of the present application, not all of them. Based on the embodiments being depicted in this application, all other implementations that would be obtained by those skilled in the art without creative labor are within the scope of protection of this application.

In the description of this application, it should be understood that the terms “center”, “up”, “down”, “front”, “back”, “left”, “right”, “vertical”, “horizontal”, “top”, “bottom”, “inside”, “outside” and other directional or positional relationships indicated are based on the accompanying drawings and are only for the convenience of describing this application and simplifying the description, and do not indicate or imply that the device or component referred to must have such a specific orientation, be constructed and operated in such a specific orientation, and therefore these terms shall not be understood as a limitation of this application.

The terms “first” and “second” are only used for descriptive purposes and should not be understood as indicating or implying relative importance or implying the number of technical features indicated. Thus, a feature being defined by “first” and “second” may explicitly or implicitly include one or more additional such features. In the description of this application, unless otherwise specified, the meaning of “multiple” refers to two or more.

In the description of this application, it should be noted that unless otherwise specified and limited, the terms “install”, “connect”, and “couple” should be broadly understood, for example, they may refer to fixed connections, detachable connections, or integral connections; they may refer to a mechanical connection, a direct connection, an indirect connection through an intermediate medium, or an internal communication between two components. For those skilled in the art, the specific meanings of the above terms in this application may be understood according to specific situations.

An electrical connector 10 (or referred to as “connector”) is proposed according to an embodiment of this application, the electrical connector 10 is configured to contain and secure electrical terminals. The electrical connector 10 may be placed within a coordinate system having X, Y, and Z axis, wherein the electrical connector 10 has several terminal channels extending along the first direction X.

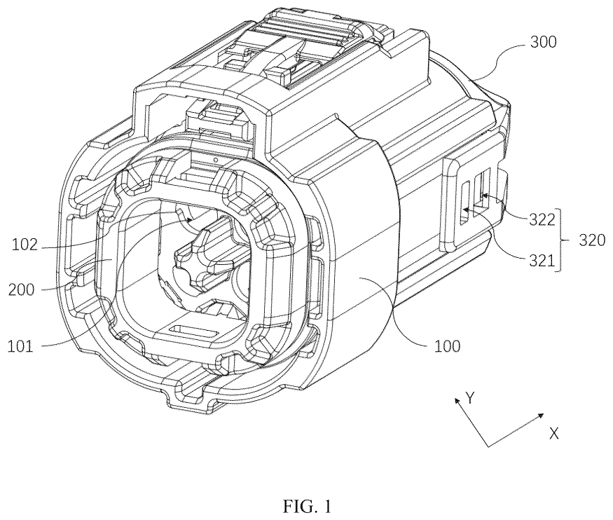

Referring now to FIGS. 1-7, the electrical connector 10 includes a main shell 100 and a terminal locking component, hereafter referred to as terminal position assurance, (TPA) 200. The TPA 200 is configured to be mated with (inserted into) the main shell 100, so as to secure the terminals with the main shell 100. The main shell 100 has one or more terminal channel(s) 101 to contain terminal to be secured. The terminal channel 101 includes an inner wall 102 which is surrounding the mounted terminal, and the inner wall 102 is configured to cooperate with the TPA 200 to firmly lock the terminal. The TPA 200 includes a base, terminal pressing plates 210, and secondary limiting plates 220 which are arranged about an axis of the first direction X. The terminal pressing plates 210 are to be mated with the main shell 100, such that the terminals in the terminal channels 101 are to be pressed against the inner wall 102. Meanwhile, when the terminals are being locked, the secondary limiting plates 220 are to be mated and secured with the main shell 100, to further define the relative position between the main shell 100 and the TPA 200, along the first direction X. Therefore, the connection stability between the main shell 100 and the TPA 200 is enhanced, and the disconnection under complex situations can be avoided.

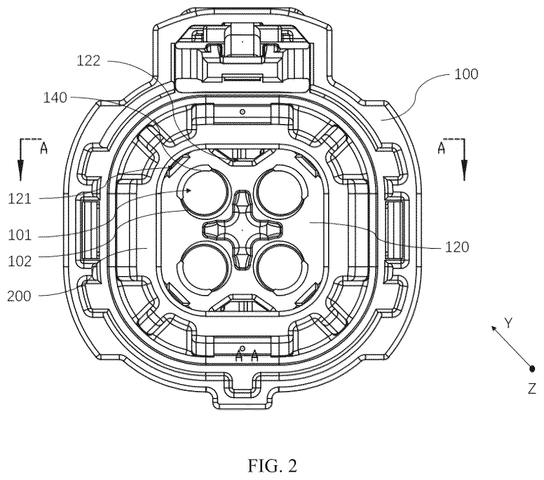

Referring now to FIGS. 2 and 4-5, in some embodiments, the main shell 100 includes a plastic housing 110 and a housing terminal positioning portion 120. The plastic housing 110 is configured to provide supporting environment for components. The housing terminal positioning portion 120 is configured to have the terminal locked in cooperation with the terminal pressing plate 210. Also, the housing terminal positioning portion 120 is to, in cooperation with the secondary limiting plate 220, have the TPA 200 secured. The plastic housing 110 has a cavity 111, the housing terminal positioning portion 120 is connected with the plastic housing and is within the cavity 111.

Referring now to FIGS. 1, 2, and 4-6, the terminal channels 101 are extending in the first direction X and are formed by the housing terminal positioning portion 120. The terminal channels 101 are penetrating the housing terminal positioning portion 120 such that the cable to be secured can enter through the terminal channels 101.

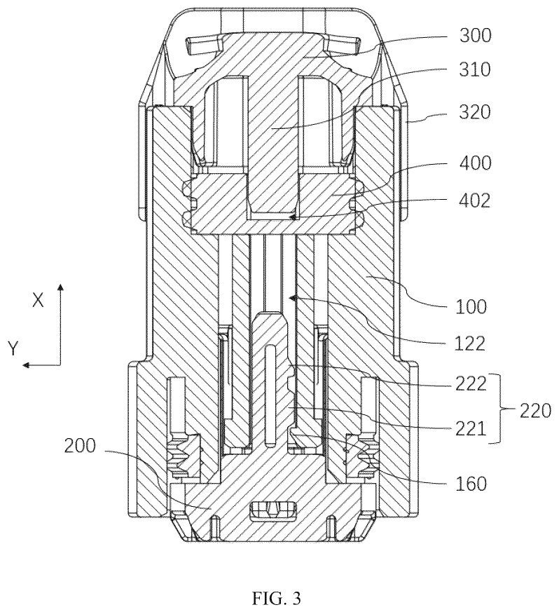

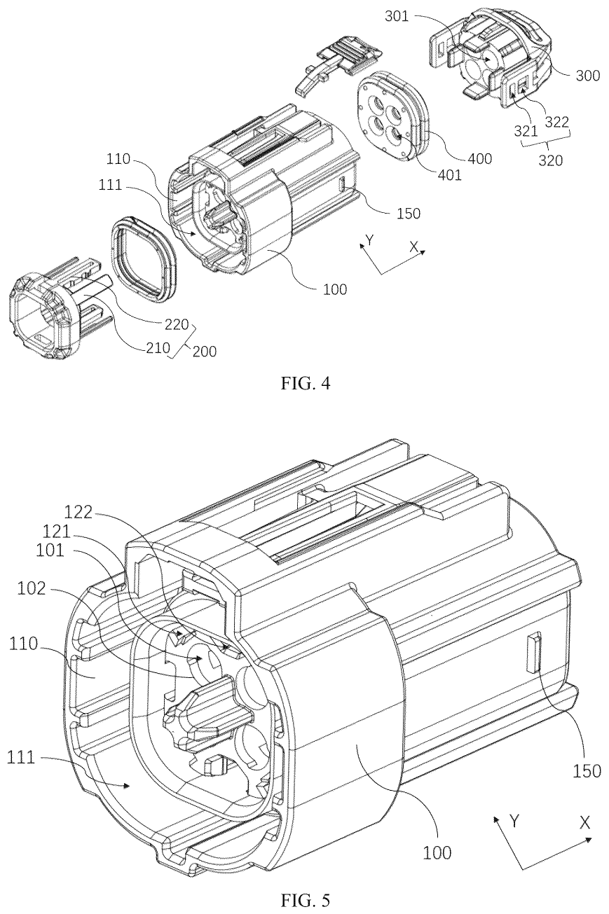

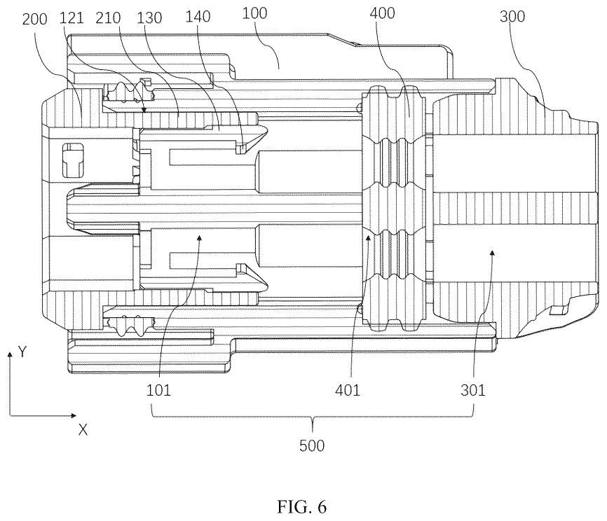

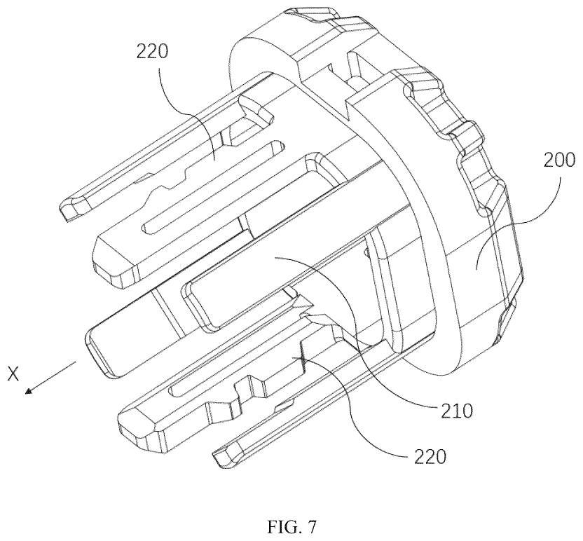

Referring now to FIGS. 1-7, the TPA 200 at least partially enters into the cavity 111, and after entrance, it mates with the housing terminal positioning portion 120 in the cavity. In particular, the terminal pressing plates 210 and the secondary limiting plates 220 are to be mated with the housing terminal positioning portion 120 respectively, wherein the mating between the terminal pressing plates 210 and the housing terminal positioning portion 120 is configured to have the terminal locked, and the mating between the secondary limiting plates 220 and the housing terminal positioning portion 120 is configured to have the TPA 200 secured.
In some embodiments, as shown, the TPA 200 is configured to be mated with the main shell 100 from the front end of the main shell 100.
Referring now to FIG. 6, the main shell 100 further includes terminal clamping arms 130, the terminal clamping arms 130 are to, in cooperation of the terminal pressing plates 210 of the TPA 200, press terminals against the inner wall 102 of the terminal channels 101. In particular, the terminal clamping arm 130 is extending along the first direction X, and at least a part of the terminal clamping arm 130 is within the terminal channel 101, such that the terminal clamping arm 130 can enter into the terminal channel 101 and apply retaining force onto terminal.
Still referring to FIG. 6, terminal clamping arm 130 is between the terminal pressing plate 210 of the TPA 200 and the terminal channel 101, such that the terminal pressing plate 210 may press down the terminal clamping arm 130, such that a retaining force may be applied to terminal. In particular, along the second direction Y as shown in FIG. 6, a side of the terminal clamping arm 130 facing away from the terminal channel 101 is configured to abut with the terminal pressing plate, and to receive the pressing force of the terminal pressing plate 210 and then apply the retaining force to the terminal.
Referring now to FIGS. 2 and 6, the main shell 100 further includes a cantilever protrusion 140, which is formed at an end of the terminal clamping arm 130, wherein the cantilever protrusion 140 is configured to apply a pressing force to terminal in the terminal channel by the deformation of the cantilever structure of the terminal clamping arm 130. In particular, along the second direction Y, the cantilever protrusion 140 is at a side of the terminal clamping arm 130 which is facing the terminal channel 101. Along the first direction X, orthographic projection of the cantilever protrusion 140 at least partially overlaps with the through-hole of the terminal channel 101, such that the cantilever protrusion 140 at least partially enter into the terminal channel 101. In some embodiments, the cantilever protrusion 140 is formed at the distal end of the terminal clamping arm 130, such that the distance between the cantilever protrusion 140, and the joint point for terminal clamping arm 130 and housing terminal positioning portion 120, is maximized.
Referring now to FIGS. 2 and 5-6, to facilitate the pressing contact between the terminal pressing plate 210 and the terminal clamping arm 130, and to facilitate the insertion of the terminal pressing plate 210 to intended position, a first guiding groove 121 is provided in the housing terminal positioning portion 120 (see the first guiding groove 121 as indicated in FIG. 2). The first guiding groove 121 is extending along the first direction X, such that the terminal pressing plate 210 can be inserted into the first guiding groove 121 along the first direction X. Along the second direction Y, the first guiding groove 121 is in communication with the terminal channel 101. In some embodiments, the terminal clamping arm 130 is within the first guiding groove 121, such that the terminal clamping arm 30 can leave the first guiding groove 121 and enter into the terminal channel 101.
Referring now to FIGS. 2-3, 5, and 7, to further enhance the stability between the main shell 100 and the TPA 200, the housing terminal positioning portion 120 also includes a first positioning groove 122. When the main shell 100 and the TPA 200 are mated, the secondary limiting plate 220 of the TPA 200 is configured to be placed into the first positioning groove 122 and is configured to be restricted in the first positioning groove 122 to define the relative position of the secondary limiting plate 220 along the first direction X. In particular, the first positioning groove 122 is extending along the first direction X, to facilitate inserting the secondary limiting plate 220 into the first positioning groove 122 along the first direction X.
Referring now to FIGS. 3 and 7, to further define the position of the secondary limiting plate 220 in the first positioning groove 122 along the first direction X, the main shell 100 further includes a lock convex portion 160. The lock convex portion 160 is formed within the first positioning groove 122. When the secondary limiting plate 220 is inserted into the first limiting groove 122 along the first direction X, the lock convex portion 160 is configured to latch with the secondary limiting plate 220, so as to define the position of the secondary limiting plate 220 in the first positioning groove 122 along the first direction X.
Still referring to FIGS. 3 and 7, to facilitate the positional restriction applied by the lock convex portion 160 of the main shell 100 to the secondary limiting plate 220, the secondary limiting plate 220 may include a first limiting protrusion 221 and a second limiting protrusion 222, the first limiting protrusion 221 and second limiting protrusion 222 are arranged along the first direction X in sequence, and are to be latched with the lock convex portion 160 so as to limit the TPA 200 at different positions. In particular, along the first direction X, the orthographic projections of the lock convex portion 160, the first limiting protrusion 221, and the second limiting protrusion 222, are at least partially overlapping.
Referring now to FIG. 3, along the first direction X, when the lock convex portion 160 is between the first limiting protrusion 221 and the second limiting protrusion 222 (the second limiting protrusion 222 being at the side away from the TPA 200, the first limiting protrusion 221 being at the side closer to the TPA 200), the terminal pressing plate 210 of TPA 200 docs not yet press down the terminal clamping arm 130, and the terminal in the terminal channel is in a loosened state. Along the first direction X, if the first limiting protrusion 221 and the second limiting protrusion 222 are both at a side of the lock convex portion 160 which is away from the TPA 200, the terminal pressing plate 210 will press down the terminal clamping arm 130, such that the terminal will be pressed and locked by the terminal clamping arm 130.
Referring again to FIGS. 3 and 7, the secondary limiting plate 220 may have a simply supported beam structure, and the first limiting protrusion 221 and the second limiting protrusion 222 are formed at lateral side of one supporting arm of the simply supported beam structure.
Referring now to FIGS. 1, 3, 4, and 6, the electrical connector 10 further includes a rear end cover 300 and a seal 400, the seal 400 is scaled with the plastic housing 110, and the seal 400 is within the cavity 111. The rear end cover 300 is configured to be mated with the main shell 100, and at least a part of the rear end cover 300 is configured to be within the cavity 111, wherein along the first direction X, the rear end cover 300 is at a side of the main shell 100 opposite to the TPA 200, and the rear end cover 300 has a second through-slot 301. One side of the seal 400 is configured to abut with the housing terminal positioning portion 120, and another side of the seal 400 is configured to abut with the rear end cover (300), and the seal 400 has a third through-slot 401. The terminal channel 101, the second through-slot 301, and the fourth through-slot 401 are in communication, to form a connection channel 500 to contain the terminal and part of the cable.
Referring now to FIGS. 3 and 4, the seal 400 is configured to be mated with the rear end cover 300, so as to enhance the accuracy of the relative position of the seal 400 and the rear end cover 300. In particular, the seal 400 has a second positioning groove 402, wherein the second positioning groove 402 has an opening facing the rear end cover 300, wherein the rear end cover 300 further includes a locating boss 310 to be inserted into the second positioning groove 402.
Still referring to FIGS. 3 and 4, multiple second positioning grooves 402 are formed on the seal 400, and multiple locating bosses 310, the number of locating bosses 310 is the same as the number of second positioning grooves 402, and each locating boss 310 is corresponding to one second positioning groove 402, such that when the rear end cover 300 is mated with the seal 400, the locating bosses 310 are to be inserted into the second positioning grooves 402 respectively.
Referring now to FIGS. 1 and 3-5, the main shell 100 further includes a limiting convex portion on the outer wall of the plastic housing, the rear end cover further includes a latching part 320. The latching part 320 is at a side of the rear end cover 300 facing the main shell 100, the latching part 320 has a first limiting slot 321 and a second limiting slot 322 which are arranged along the first direction X in sequence. The limiting convex portion 150 is restricted by the first limiting slot 321 or the second limiting slot 322.
In some embodiments, when the terminal is not being locked, the limiting convex portion 150 is in the first limiting slot 321, and when the terminal is being locked, the limiting convex portion 150 is in the second limiting slot 322.
When the electrical connector 10 is being used to contain and secure terminals, the terminal pressing plate 210 is configured to be inserted into the first guiding groove 121, and the secondary limiting plate 220 is inserted into the first positioning groove 122, and the lock convex portion 160 is between the first limiting protrusion 221 and the second limiting protrusion 222. At this time, the terminal pressing plate 210 does not yet press down the terminal clamping arm 130. Along the first direction X, the cable will pass through the second through-slot 301 and the third through-slot 401 to enter into the terminal channel 101.
When the terminal is placed at intended position, the position of the terminal pressing plate 210 in the first guiding groove 121 can be adjusted such that the terminal pressing plate 210 presses down the terminal clamping arm 130, such that the terminal clamping arm 130 applies a force to terminal within the terminal channel 101. At the same time, the position of the secondary limiting plate 220 in the first positioning groove 122 is adjusted accordingly, such that both the first limiting protrusion 221 and the second limiting protrusion 222 are at a side of the lock convex portion 160 away from the TPA 200.
This application provides a detailed introduction to a connector provided in the embodiments of the present application. Specific examples are provided to explain the principles and implementation methods of the present application. The above embodiments are only used to help understand the method and core idea of the present application. Meanwhile, for a person skilled in the art, based on the ideas of this application, changes in the specific implementation approaches are possible. Therefore, the content of this specification should not be understood as limiting this application.

1. An electrical connector, comprising:
a main shell having one or more terminal channels extending along a first direction, the one or more terminal channels configured to contain terminals; and
a terminal locking component is configured to be mated with the main shell, the terminal locking component comprises a base, a terminal pressing plate, and a secondary limiting plate, the terminal pressing plate is configured to apply a retaining force to the terminals within the one or more terminal channels, the secondary limiting plate is configured to define a relative position between the main shell and the terminal locking component.

2. The electrical connector of claim 1, wherein the main shell further comprises a plastic housing and a housing terminal positioning portion connected with the plastic housing, the plastic housing has a cavity, wherein the housing terminal positioning portion is positioned within the cavity, wherein the one or more terminal channels are formed by the housing terminal positioning portion, and wherein the terminal locking component is configured to be at least partially within the cavity, the terminal locking component is configured to be mated with the housing terminal positioning portion.

3. The electrical connector of claim 2, wherein the main shell further comprises a terminal clamping arm extending along the first direction and configured to be at least partially disposed within the terminal channel, wherein a side of the terminal clamping arm facing away from the terminal channel is configured to abut with the terminal pressing plate along a second direction intersecting with the first direction, and wherein another side of the of the terminal clamping arm closer to the terminal channel is configured to apply retaining force to the terminals in the one or more terminal channels.

4. The electrical connector of claim 3, wherein the main shell further comprises a cantilever protrusion formed at an end of the terminal clamping arm and wherein an orthographic projection of the cantilever protrusion at least partially overlaps with a through-hole of the terminal channel along the first direction.

5. The electrical connector of claim 4, wherein the housing terminal positioning portion has a first guiding groove extending along the first direction, wherein the first guiding groove is in communication with the terminal channel along the second direction, and wherein the terminal pressing plate is configured to be placed within the first guiding groove when the main shell and the terminal locking component are mated.

6. The electrical connector of claim 5, wherein the secondary limiting plate has a simply supported beam structure.

7. The electrical connector of claim 5, wherein the housing terminal positioning portion further comprises a first positioning groove and wherein the secondary limiting plate is configured to be placed into the first positioning groove and is configured to be restricted in the first positioning groove to define the relative position of the secondary limiting plate along the first direction when the main shell and the terminal locking component are mated.

8. The electrical connector of claim 7, wherein the main shell further comprises a lock convex portion, the lock convex portion is formed within the first positioning groove, wherein the lock convex portion is configured to latch with the secondary limiting plate so as to define the position of the secondary limiting plate in the first positioning groove along the first direction.

9. The electrical connector of claim 8, wherein the secondary limiting plate comprises a first limiting protrusion and a second limiting protrusion, wherein the first limiting protrusion and second limiting protrusion are arranged along the first direction in sequence; and wherein the orthographic projections of the lock convex portion, the first limiting protrusion, and the second limiting protrusion, are at least partially overlapping along the first direction.

10. The electrical connector of claim 2, wherein the electrical connector further comprises:
a rear end cover configured to be mated with the main shell, wherein at least a part of the rear end cover is configured to be within the cavity, wherein the rear end cover is at a side of the main shell opposite to the terminal locking component along the first direction, and wherein the rear end cover has a second through-slot; and
a seal sealed with the plastic housing and located within the cavity, wherein one side of the seal is configured to abut with the housing terminal positioning portion and another side of the seal is configured to abut with the rear end cover, wherein the seal has a third through-slot, and wherein the terminal channel, the second through-slot and a fourth through-slot are in communication, to form a connection channel to contain the terminal and part of a cable.

11. The electrical connector of claim 10, wherein the seal has a second positioning groove, having an opening facing the rear end cover and wherein the rear end cover further comprises a locating boss to be inserted into the second positioning groove.

12. The electrical connector of claim 10, wherein the main shell further comprises a limiting convex portion on an outer wall of the plastic housing, the rear end cover further comprises a latching part located at a side of the rear end cover facing the main shell, wherein the latching part has a first limiting slot and a second limiting slot which are arranged along the first direction in sequence, and wherein the limiting convex portion is restricted by the first limiting slot or the second limiting slot.

13. The electrical connector of claim 1, wherein the terminal locking component is configured to be mated into the main shell from a front end of the main shell.

14. The electrical connector of claim 1, wherein there are two secondary limiting plates are symmetrically arranged.

15. The electrical connector of claim 1, wherein the number of the terminal pressing plates is equal to the number of terminals to be contained in the main shell.
